(19) United States
(12) Patent Application Publication
(10) Pub. No.: US 2008/0191400 A1
(43) Pub. Date: Aug. 14, 2008

(54) Spring formed with an abnormal-shaped cross section specially used as a vehicle shock absorber

(76) Inventor: Ching-Liaug Liu, Kaohsiung Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/704,378

(22) Filed: Feb. 9, 2007

(51) Int. Cl. F16F 7/00

(52) U.S. Cl. 267/195

(57) ABSTRACT

A spring formed with an abnormal-shape cross section (a non-circular cross section) specially used as a vehicle shock absorber is a string whose cross section is shaped rectangular, trapezoidal, single-edge arced or oval. Compared with a spring formed with a circular-shape cross section, the spring formed with one of foresaid abnormal-shape cross sections has some or all of the following functions: The stroke can be increased under the condition of a same free height; it can be prevented from broken after its load area is enlarged; it can reduce weight under the condition of a same stroke; it can enhance resistance to huge outer stress and thus prolong its service life and it can be received and positioned in a very small space.

### BACKGROUND OF THE INVENTION

1. Field of the Invention

This invention relates to a spring formed with an abnormal-shape cross section specially used as a vehicle shock absorber, particularly to one able to reduce its weight, increase its stroke and bear high stress.

2. Description of the Prior Art

A conventional shock-absorbing spring specially used for automobiles, motorcycles and bikes is formed with a circular-shape cross section, but such a shock-absorbing spring is limited in the capacity of bearing stress and insufficient in working stroke and also excessively long and heavy, always causing difficulty in assembly, increasing cost and not conforming to economic gain.

### SUMMARY OF THE INVENTION

The objective of this invention is to offer a spring formed with an abnormal-shape cross section specially used as a vehicle shock absorber. The spring of this invention is formed with a rectangular-shape, a trapezoid-shape, an oval-shape or a single-edge curved cross section, having characteristics of light weight and large stroke.

A spring formed with a rectangular-shape cross section can increase 15-35% of stroke, compared with a spring formed with a circular-shape cross-section under the condition of a same length, and can lessen 10-30% of weight in comparison with the spring formed with a circular-shape cross-section in case of a same stroke, able to increase stroke, reduce weight and lower cost.

A spring formed with a trapezoid-shape cross section not only has the same characteristics of light weight and large stroke as the spring formed with a rectangular-shape cross section, but also can bear comparatively large stress. Compared with a spring formed with a circular-shape cross section, the spring formed with a trapezoid-shaped cross section can elevate 15% of service stress or bearing stress so it can avoid elasticity fatigue or breakage, able to insure safety in use and prolong service life.

A spring formed with single-edge curved cross section, compared with a spring formed with a circular-shape cross section, has a longer stroke under the condition of a same length, and has a lighter weight if they are of a same stroke, able to lessen weight, enlarge stroke and lower cost.

A spring formed with an oval-shape cross section is much better than a spring formed with a circular-shape cross section in quality although its characteristics in decreasing weight and increasing stroke is not so obvious as that of a spring formed with a rectangular-shape or with a trapezoid-shape cross section. Compared with the spring formed with other shape cross sections, the spring formed with an oval-shape cross-section can greatly improve the problem of concentration of service stress. When used, the spring formed with an oval-shape cross section can disperse the service stress so it can be used on a occasion that requires comparatively high stress, able to prolong service life, and especially it can be installed at a place that needs the spring small in size but long in stroke.

### BRIEF DESCRIPTION OF DRAWINGS

This invention will be better understood by referring to the accompanying drawings, wherein:

FIG. 1 is a cross-sectional view of a spring formed with a rectangular-shape cross section in the present invention;

FIG. 2 is a cross-sectional view of a spring formed with a trapezoid-shape cross section in the present invention;

FIG. 3 is a cross-sectional view of a spring formed with a single-edge curved cross section in the present invention; and

FIG. 4 is a cross-sectional view of a spring formed with an oval-shape cross section in the present invention.

### DETAILED DESCRIPTION OF THE PREFERRED EMBODIMENT

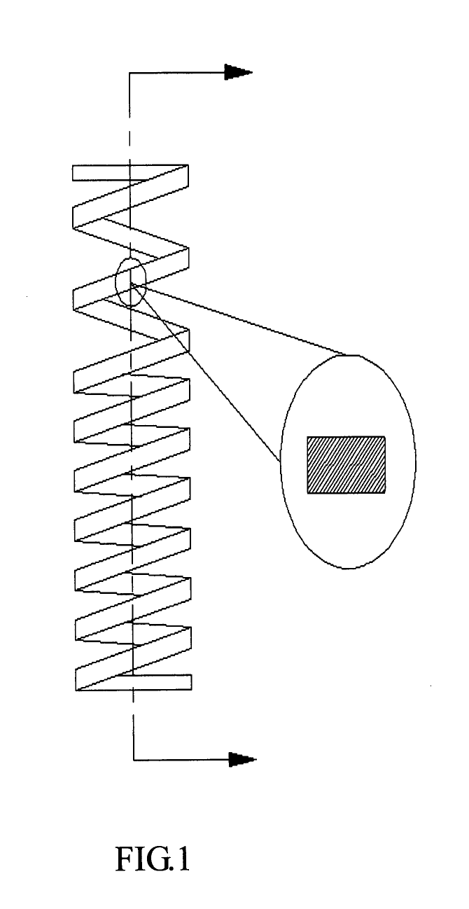

A first preferred embodiment of a spring formed with an abnormal-shape cross section specially used as a vehicle shock absorber in the present invention, as shown in FIG. 1, is a spring formed with a rectangular-shape cross section. Such a spring can increase 15%˜35% of stroke in comparison with a spring formed with a circular-shape cross section under the condition of a same length, and can reduce 10%˜30% of weight if they are of the same stroke. The so-called stroke means a remaining length of space in a certain spring-assembling space after the spring is tightly compressed.

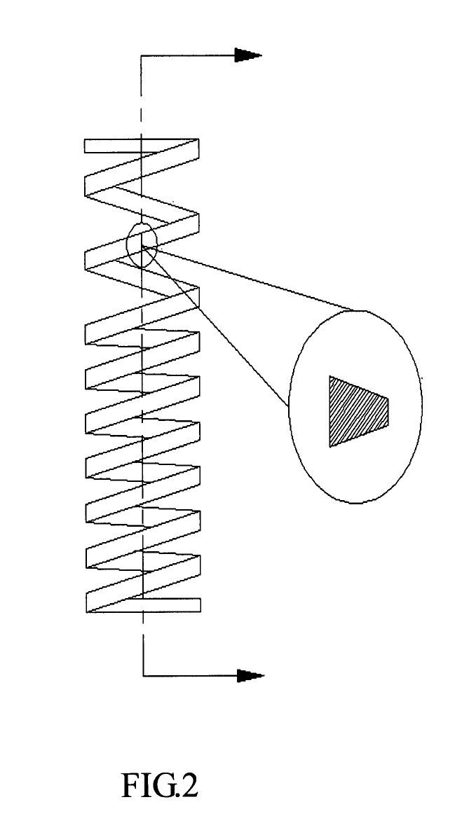

A second preferred embodiment of a spring formed with an abnormal-shape cross section specially used as a vehicle shock absorber in the present invention, as shown in FIG. 2, is a spring formed with a trapezoid-shape cross section. Apart from having the same characteristics of light weight and large stroke as the spring formed with a rectangular-shape cross section, the spring formed with a trapezoid-shape cross section can increase 5% of service stress in comparison with a spring formed with a circular-shape cross section, hardly causing elasticity fatigue or breakage, and thus insuring safety in use and prolonging service life.

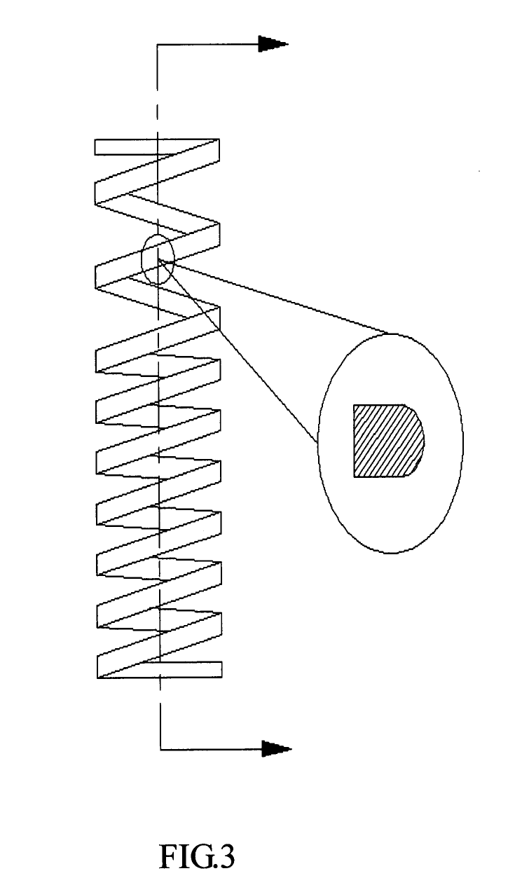

A third preferred embodiment of a spring formed with an abnormal-shaped cross section specially used as a vehicle shock absorber in the present invention, as shown in FIG. 3, is spring formed with a single-edge curved cross section. Compared with a spring formed with a circular-shape cross section, the spring formed with a single-edge curved cross section can increase its stroke under the condition of a same length, and can lessen its weight in case they are the same in stroke, having characteristics of light weight, large stroke and low cost.

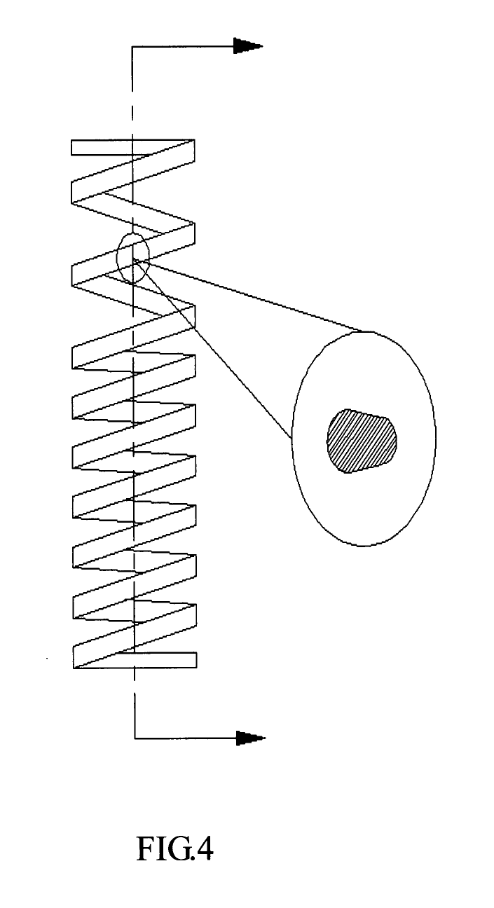

A fourth preferred embodiment of a spring formed with an abnormal-shape cross section specially used for a vehicle shock absorber in the present invention, as shown in FIG. 4, is a spring formed with oval-shape cross section, which is much better than a spring formed with a circular-shape cross section in decreasing weight and increasing stroke. During working, the spring with a circular-shape cross-section has its cross-sectional stress concentrated on the fixing points of its inner diametrical edge; therefore, when used over limiting time, it is likely to be broken. The spring with an oval-shape cross-section can disperse service stress to solve the problem of concentration of cross-sectional stress, applicable to places that require high stress and able to prolong service life.

While the preferred embodiments of the invention have been described above, it will be recognized and understood that various modifications may be made therein and the appended claims are intended to cover all such modifications that may fall within the spirit and scope of the invention.

I claim:

1. A spring formed with an abnormal-shape cross section specially used as a vehicle shock absorber, said spring formed with a non-circular cross section, said spring having characteristics of light weight and large stroke, and able to bear comparatively high stress.

2. The spring formed with an abnormal-shape cross-section specially used as a vehicle shock absorber as claimed in claim 1, wherein said cross section of said spring is shaped rectangular.

3. The spring formed with an abnormal-shape cross-section specially used as a vehicle shock absorber as claimed in claim 1, wherein said cross section of said spring is shaped trapezoidal.

4. The spring formed with an abnormal-shape cross-section specially used as a vehicle shock absorber as claimed in claim 1, wherein said cross section of said spring is shaped single-edge arced.

5. The spring formed with an abnormal-shape cross-section specially used as a vehicle shock absorber as claimed in claim 1, wherein said cross section of said spring is shaped oval.
